(19) United States
(12) Patent Application Publication
(10) Pub. No.: US 2003/0187687 A1
(43) Pub. Date: Oct. 2, 2003

(54) Digital print order receipt system

(75) Inventor: Matsuyuki Miwa, Kanagawa (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/401,689

(22) Filed: Mar. 31, 2003

(30) Foreign Application Priority Data
Mar. 29, 2002 (JP) 2002-094247

(51) Int. Cl. G06F 17/60

(52) U.S. Cl. 705/1

(57) ABSTRACT

The digital print order receipt system includes a plurality of digital print order receipt terminals in shops or users' PCs, a plurality of printer controllers located on a remote site distant from the shops and users' PCs, and connected to the order receipt terminals or users' PCs via a network and printers at least one of which is connected to each of printer controllers, each printer being controlled by each printer controller. The printer controller makes rounds of print orders in users' PCs and order receipt terminals as well as operating states of printers connected to the other printer controllers, and determining that there is a print order optimum for printer controller, fetches image data corresponding to the optimum print order from the order receipt terminal or users' PCs having the optimum print order and produces a print on a printer connected to the printer controller.

### BACKGROUND OF THE INVENTION

This invention relates to a digital print order receipt system, more particularly, to a digital print order receipt system which connects a plurality of DP (digital print) receipt terminals and a plurality of printers via a network in order to efficiently handle a plurality of print orders.

In a prior art photo print order receipt system, a user brings an exposed film to a DP (prints with film processing) order receipt shop such as a photo shop, convenience store or bookstore in order to ask printing of the film and receives the finished print on the delivery date specified at reception of print order or later.

The DP order receipt shop processes the exposed film received from the user on the spot or sends the film to a laboratory for processing of the negative film to produce a print.

In order to process an exposed film and produce a print on the spot, the DP order receipt shop has to install in the shop a small-sized printer equipped with a processor. Further, the shop must control the solution volume and temperature of a developer and a fixer in the shop. In case the shop does not install a printer in the shop and sends an exposed film to a large-scale laboratory on another site for printing, it takes time from a print order by the user to delivery of the print.

Recently, a system has been in practical use which digitally reads image information from a photograph manuscript such as a photo negative and converts the information to a digital image signal, and regenerates the digital image signal to obtain a photo print. Widespread use of sophisticated personal computers (PCs), digital cameras and scanners has enabled image processing on a PC and digital printing on a personal-use ink-jet printer or thermal printer.

However, a high-quality print cannot be expected from such personal-use printers. Print cost is high considering the printer purchase cost.

Thus, a system is proposed where, with an image input unit to receive print orders installed in a shop, the print order receipt shop inputs image data as a digital image signal or inputs the image data and converts the image data to a digital image signal then sends the digital image signal to a laboratory on a remote site, or a user directly sends digital image data to the laboratory, which outputs as a print the image data onto a printer (image output unit) installed therein and returns the print to the print order receipt shop or directly to the user.

According to the system, it is not necessary to install a processor or a printer thus allowing space saving in the shop. The image data is sent as a digital image signal, which speeds up the processing. An image recording medium such as a negative and a smart medium can be returned to a user on the spot once image data is read at reception of a print order, because the medium is no longer necessary.

In a prior art digital photo print order receipt system, a user or an operator in a photo print order receipt shop must choose a laboratory on a remote site as a destination of image data before sending the image data for printing on a printer in the laboratory. Thus, the delivery time for a finished print is manually controlled by a printer operator in the laboratory on a remote site. Further, load distribution among printers in the laboratories is not optimized. These problems lead to excessively inefficient processing.

### SUMMARY OF THE INVENTION

The invention has been accomplished in order to solve the aforementioned problems and aims at providing a digital print order receipt system which connects a plurality of DP order receipt terminals and a plurality of printers via a network and automatically controls the delivery time for finished prints and load distribution among printers for optimized process control.

In order to attain the object described above, the present invention provides a digital print order receipt system comprising:

a plurality of digital print order receipt terminals in shops or personal computers of users;

a plurality of printer controllers located on a remote site distant from the shops and the personal computers of users, the plurality of printer controllers being connected to the plurality of digital print order receipt terminals or personal computers of users via a network; and

printers at least one of which is connected to each of the plurality of printer controllers, each printer being controlled by each printer controller;

wherein one of the plurality of printer controllers makes rounds of print orders in the personal computers of users and the plurality of digital print order receipt terminals as well as operating states of printers connected to the other printer controllers, and determining that there is a print order optimum for printer controller, fetches image data corresponding to the optimum print order from the digital print order receipt terminal or personal computers of users having the optimum print order and produces a print on a printer connected to the printer controller.

Preferably, the printer controller determines the optimum print order based on the information on the print order obtained as a result of the round and the operating state of each printer.

Here, the information on the print order may include a print type, delivery time and the like. In addition, the operating state of each printer refers to the operating state of a printer connected to the other printer controllers and to a printer connected to the printer controller.

Preferably, the printer controller makes rounds of print orders in the personal computers of users and the order receipt terminals as well as the operating states of the printers connected to the other printer controllers, automatically determines the delivery time for the order assumed in case a print is produced on a printer connected to the printer controller, and communicates the automatically determined delivery time for the order to the digital print order receipt terminal or the user's PC.

Preferably, in case a printer connected to the printer controller is detected faulty by another printer controller while it is making rounds, the other printer controller fetches the image data corresponding to the print order to be handled by the faulty printer and produces a print on a printer connected to the other printer controller thereby avoiding a delay in a delivery time for the order.

### BRIEF DESCRIPTION OF THE DRAWINGS

FIG. 1 is a general block diagram showing an embodiment of a digital print order receipt system of the invention.

### DETAILED DESCRIPTION OF THE INVENTION

The digital print order receipt system of the invention is described below in detail with reference to the preferred embodiments shown in the accompanying drawings.

A digital print order receipt system according to the invention is a system where a plurality of digital print order receipt terminals in shops and a set of printers on remote sites and controllers for controlling the printers are connected via a network. When a digital print is ordered from a digital print order receipt terminal or a user's PC, the image data of the order is copied, together with order information (print order information), to a specific folder of the terminal or PC. Each printer controller makes rounds of print orders in the order receipt terminals and users' PCs. At the same time, the printer controller makes rounds of the operating states (load conditions) of the printers connected to the other printer controllers, determines a print order optimum for the printer controller and fetches the corresponding image data from the print order receipt terminal or user's PC to produce a print, thereby allowing load distribution among printers and optimized process control of the system.

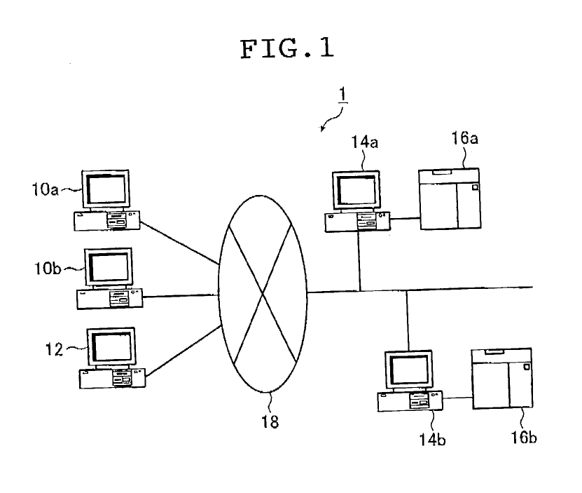

FIG. 1 is a general block diagram of an embodiment of a digital print order receipt system of the invention.

As shown in FIG. 1, a digital print order receipt system 1 comprises a plurality of digital print order receipt terminals 10a, 10b and a user's PC 12, a plurality of printer controllers 14a, 14b in laboratories and printers 16a, 16b respectively connected to the printer controllers, interconnected via a network 18.

The digital print order receipt terminals (hereinafter simply referred to as an order receipt terminal) 10a, 10b each comprises a computer, to which are connected, for example, image input means for inputting digital image data from an image recording medium such as a SmartMedia where an image shot by a digital camera is recorded, and a keyboard for inputting order information.

The order information includes an item for identifying a customer (user), print size, print type and delivery time desired by the user.

The digital image data and order information, once input, is stored into a predetermined memory (specific folder) of the order receipt terminal (computer) 10a or 10b.

The installation place of the order receipt terminals 10a, 10b is not limited. A processor or a printer need not be installed at the same time so that only a small space is required to install an order receipt terminal. Thus, the order receipt terminal is preferably installed in a supermarket, convenience store, bookstore or station.

Image data to be input may be data other than digital image data. For example, a photo negative may be read photoelectrically on a scanner connected to a computer and the resulting data may be converted to digital image data.

The user's PC 12 is a PC, which, for example, a photo enthusiast has registered to this system and is connected to the network 18. The user inputs digital image data to the PC 12 by reading the data from an image recording medium by way of image input means connected to the PC 12. Or, the user directly inputs digital image data to the PC 12 from a digital camera. The user inputs order information from a keyboard.

The form of image data or order information is unified by previously given order software. The image data or order information is input in the same form as that accepted by the order receipt terminals 10a, 10b.

Each printer 16a, 16b is a so-called digital photoprinter which produces a print by scanning and exposing to light a photosensitive material by using a light beam modulated in accordance with image data. The printer controllers 14a, 14b are computers controlling the printers 16a, 16b respectively.

The printer controllers 14a, 14b and the printers 16a, 16b are interconnected respectively and the resulting two sets of a printer controller and a printer are connected to the network 18. While the printer controllers 14a, 14b and the printers 16a, 16b correspond on a one-to-one basis in the example shown, a plurality of printers may be connected to a single printer controller and a single controller may control a plurality of printers.

In case printer controllers correspond on a one-to-one basis, a computer as a printer controller may be a standalone unit separate from the printer or incorporated in a printer.

Each set of the printer controllers 14a, 14b and the printers 16a, 16b may be installed in a single laboratory shop. Or a plurality of sets may be installed in a single large-scale laboratory.

The printer controllers 14a, 14b and the printers 16a, 16b are installed on remote sites distant from the digital print order receipt terminal 10a, 10b and the user's PC 12 It is not mandatory that these controllers and printers be installed at remote sites. In this system, processing is possible without delay even at a remote site because digital image data is transmitted via the network 18.

The network 18 is a Virtual Private Network (VPN) using the same circuit as that for the Internet. This is an intraoffice network and same as a LAN (Local Area Network) from the viewpoint of an application.

The mode of operation of this embodiment is described below.

While the printer controller 14a is described below, another printer controller 14b has the same operation.

The user visits a shop where an order receipt terminal 10a is installed and makes a digital print order. The operator sets the image recording medium of the user on image input means and inputs image data to the order receipt terminal 10a. The operator takes an order from the user and inputs order information from a keyboard. Order information may be recorded onto an image recording medium as an additional data to the image data and may be read from the recording medium as required.

The input image data and order information are stored into a memory (specific folder) of the order receipt terminal 10a.

The user having a PC 12 registered to the network 18 need not visit a shop but may place a print order from his/her PC 12. The user has only to input image data and order information to a specific folder in the PC 12 in accordance with previously given software.

Assume that several print orders exist in each order receipt terminal 10a, 10b or user's PC 12.

The printer controller 14a makes rounds of the order receipt terminals (such as 10a) and user's PC (such as 12) on a routine basis and retrieves print order information in the memory (specific folder) of each order receipt terminal.

The printer controller 14a also makes rounds of the operating state (load condition) of the printer 16b controlled by another printer controller 14b in order to constantly grasp the condition of another printer such as the printer 16b. The printer controller 14a naturally grasps the operating state of the printer 16a which is under its control.

The printer controller 14a makes rounds of the order receipt terminals (such as 10a) and detects information on the print orders stored in the terminals. The printer controller 14a determines a print order optimum for itself with all things considered from the details of the orders as well as the operating states of the other printers and the printer controller 14a.

The printer controller 14a automatically determines which print order is optimum for itself based on the number of prints, print size, print type, user's desired delivery time and its own load condition.

For example, in case memory to accept image data is insufficient because there are a large number of prints, or in case paper to fit the print size or print type is not provided on the printer 16a, print execution is not allowed and the corresponding print order is not accepted.

In case the ordered print is executable judging from the details of order including the image data amount and print size, and the user's desired delivery time is more likely to be observed than any other printers from the viewpoint of the current operating state, the printer controller 14a determines the order as optimum for itself and accepts the order.

The printer controller 14a may automatically determine its own possible delivery time, that is, until what time of what day the print will have been finished on the printer 16a under its control, and communicate the delivery time to the order receipt terminal 10a.

The printer controller 14a, in case it has determined that the print order stored in an order receipt terminal (such as 10a) is the optimum for the printer controller 14a, fetches image data corresponding to the print order from a specific folder of the order receipt terminal 10a via the network 18. In this practice, the fact that the print order has been accepted (handled) is recorded on the order receipt terminal 10a.

This prevents a print order from being handled by more than one printer in a duplicated way. Further, setting may be provided on the order receipt terminal 10a in advance so that the image data stored in the order receipt terminal 10a will be erased when the image data is fetched by the printer controller 14a. This prevents duplicated processing and reduces the load on the memory of the order receipt terminal.

The printer controller 14a temporarily stores the image data corresponding to the print order into memory, and once the printer 16 becomes unoccupied, sends the image data to the printer 16a and outputs the print on the printer 16a.

In this way, as a rule, the printer controller 14a searches order receipt terminals for print orders in this embodiment. In case there are several print orders, the printer controller 14a automatically determines the print order optimum for itself and produces a print.

While the printer controller 14a fetches the image data corresponding to the print order from an order receipt terminal in this embodiment as mentioned earlier, the printer 16a controlled by the printer controller 14a may be directly connected to the network 18 and the printer 16a may receive image data directly from the order receipt terminal 10a via the network 18 based on an instruction from the printer controller 14a.

While each printer 16a, 16b provides paper of different size or different type to automatically accept various orders from users, it is burdensome and wasteful to constantly provide paper of all sizes or types. For example, a single printer may be used as a printer dedicated to special prints in order to produce special prints such as prints of a special size less frequently ordered, and an operator may replace paper in accordance with incoming print orders.

A print output from the printer 16a is delivered to a user by way of a method specified by the user in advance.

The user's print receiving method is not limited but various methods are possible. For example, the printer 16a may send a print to a shop having the order receipt terminal 10a installed therein where the user receives the print, directly send a print to the user's home, or send it to a shop such as a convenience store under contract near the user's home, where the user receives the print.

In any case, the user specifies the print receiving method in advance at print order making.

In case the printer controller 14a has found a faulty printer while it is making rounds of the printer controllers such as a printer controller 14b, the printer controller 14 accepts the print order, if possible, based on the details of the print order the faulty printer is to handle, operating states of the other printers and the printer controller 14a. That is, the printer controller 14a fetches the image data corresponding to the target order stored in the printer controller for the faulty printer and prints the image data.

In this way, by using another printer to fetch a print order stored in a printer which has gone faulty and to produce a print, it is possible to avoid a significant delay in the delivery time for the order.

As detailed hereinabove, according to this embodiment, a user has only to input the digital image data corresponding to the print order into an order receipt terminal in a shop or a specific folder of a PC registered to a network of the user's own. Printer controllers at a remote site automatically make rounds of print orders via a network to search for print orders. Each printer controller takes charge of print orders optimum for the printer controller, thus allowing optimized process control of the system and load distribution among printers.

In this way, by efficiently operating the system, it is possible to satisfy a user's desired print order.

While the digital print order receipt system of the invention has been detailed, the print order receipt system of the invention is by no means limited to the foregoing embodiments and various improvements and modifications are possible without departing from the spirit and scope of the invention.

As described on the foregoing pages, the print order receipt system of the invention provides automated control of the delivery date for a finished print and load distribution among printers at acceptance of a digital print order, thereby allowing optimized process control.

What is claimed is:

1. A digital print order receipt system comprising:
a plurality of digital print order receipt terminals in shops or personal computers of users;
a plurality of printer controllers located on a remote site distant from said shops and said personal computers of users, said plurality of printer controllers being connected to said plurality of digital print order receipt terminals or personal computers of users via a network; and
printers at least one of which is connected to each of said plurality of printer controllers, each printer being controlled by each printer controller;
wherein one of said plurality of printer controllers makes rounds of print orders in said personal computers of users and said plurality of digital print order receipt terminals as well as operating states of printers connected to the other printer controllers, and determining that there is a print order optimum for printer controller, fetches image data corresponding to the optimum print order from the digital print order receipt terminal or personal computers of users having the optimum print order and produces a print on a printer connected to the printer controller.

2. The digital print order receipt system according to claim 1, wherein said printer controller determines said optimum print order based on the information on the print order obtained as a result of said round and the operating state of each printer.

3. The digital print order receipt system according to claim 1, wherein said printer controller makes rounds of print orders in said personal computers of users and said order receipt terminals as well as the operating states of the printers connected to the other printer controllers, automatically determines the delivery time for the order assumed in case a print is produced on a printer connected to the printer,controller, and communicates said automatically determined delivery time for the order to said digital print order receipt terminal or said user's PC.

4. The digital print order receipt system according to claim 1, wherein, in case a printer connected to said printer controller is detected faulty by another printer controller while it is making rounds, said other printer controller fetches the image data corresponding to the print order to be handled by said faulty printer and produces a print on a printer connected to the other printer controller thereby avoiding a delay in a delivery time for the order.
